(19) United States
(12) Patent Application Publication
(10) Pub. No.: US 2026/0288672 A1
(43) Pub. Date: Sep. 24, 2026

(54) Use of PCIE and Clustering in AI and LLM Environments.

(71) Applicant: Mammen Thomas, Seattle, WA (US)

(72) Inventor: Mammen Thomas, Seattle, WA (US)

(21) Appl. No.: 19/690,399

(22) Filed: May 28, 2026

Related U.S. Application Data
(63) Continuation-in-part of application No. 18/205,515, filed on Jun. 3, 2023.
Application No. 18/205,515 is a continuation of application No. 17/858,083, filed on Jul. 6, 2022, now abandoned.
Application No. 17/858,083 is a continuation of application No. 17/523,878, filed on Nov. 10, 2021, now abandoned.

(51) Int. Cl. G06F 13/42; G06F 13/40; H04L 49/40

(52) U.S. Cl. CPC G06F 13/4282; G06F 13/4022; G06F 13/4221; H04L 49/40; G06F 2213/0026

(57) ABSTRACT

Peripheral component Interconnect Express (PCIE) is an interconnect standard implemented as a tree network for connecting to peripheral devices to central processing units (CPU)s. Currently PCIE has become a basis for high speed interconnect applications. U.S. Pat. No. 11,194,754 describes a PCIE based interconnect scheme for data transport between the connected clusters of processing systems. PCIE interconnect using PCIE protocol is proposed for data transfer within and between the clusters of interconnected processors, memory modules, memory controllers, storage and other network components used in artificial intelligence (AI) systems with machine learning (ML) in large language model environments. The proposed architecture eliminates protocol changes and associated latency allowing high speed, high volume data transfer. The capability for remote direct memory access (RDMA) and direct memory access (DMA) capability provided by such PCIE based clusters without CPU involvement further enhances the speed of Data transfer.

### CROSS REFERENCE TO RELATED APPLICATIONS

This application is a continuation-in-part of U.S. application 18/205,515 filed on Jun. 3, 2023 which is pending and which is a continuation of U.S. patent application Ser. No. 17/858,083 filed on Jul. 6, 2022 Titled: “PCI Express to PCI Express based low latency interconnect scheme for clustering systems”, which has been abandoned, which claims priority to U.S. patent application Ser. No. 17/523,878, titled “PCI Express to PCI Express based low latency interconnect scheme for clustering systems” filed on Nov. 10, 2021 which has been abandoned, which claims priority to U.S. patent application Ser. No. 15/175,800 titled “PCI Express. To PCI Express based low latency interconnect scheme for clustering systems” filed on Jun. 7, 2016, which issued as U.S. Pat. No. 11,194,754 of Dec. 7, 2021 which is a continuation of U.S. application Ser. No. 14/588,937 titled “PCI Express. To PCI Express based low latency interconnect scheme for clustering systems” filed on Jan. 3, 2015 which issued as a U.S. Pat. No. 9,519,708 on Dec. 13, 2016 is a continuation of U.S. patent application Ser. No. 13/441,883 titled “PCI Express to PCI Express based low latency interconnect scheme for clustering systems” filed on Apr. 8, 2012, currently abandoned, which is a continuation of U.S. patent application Ser. No. 11/242,463 titled “PCI Express to PCI Express based low latency interconnect scheme for clustering systems” filed on Oct. 4, 2005 which issued as U.S. Pat. No. 8,189,603 on May 29, 2012, all of which have a common inventor, and are hereby incorporated by reference for all that they contain.

### TECHNICAL FIELD

The invention generally relates to providing high speed interconnect between systems within an interconnected cluster of systems and specifically relates to providing high speed, high volume data transfer capability between systems comprising processing units, memory modules, storage and other sub-systems and peripheral modules. The PCIE based clustering when used with AI with ML capability and Large language models enable high speed, high volume data transfer between the interconnected systems. It also provides for RDMA and DMA capability within the clustered systems.

### BACKGROUND AND PRIOR ART

The need for high speed and low latency cluster interconnect scheme for data and information transport between systems have been recognized as a limiting factor to achieving reliable, high speed operation of advanced systems with artificial intelligence (AI) with machine learning (ML) capability in the current Large Language Model (LLM) environments. The speed and reliability of data transfer has been identified as one needing immediate attention to resolve for the growth of AI. The growth of interconnected and distributed processing schemes have also made it essential that high speed interconnect schemes to be defined and established to provide the speeds necessary to take advantage of the high speeds being achieved by data processing systems such as central processing units (CPU)s and graphic processing units (GPU)s and enable faster data sharing between interconnected systems. This has become more and more of a need as AI systems handling large amounts of data has become the norm. Almost all interconnect streams other than PCI express interconnect require moving from one protocol to another for data transfer. This creates higher latency and slows down transfer speeds.

The PCI Express interconnect today provides a solution to the problem with the PCIE 7 version providing 256 GB/second speeds with 16 lanes today and PCIE 8 specified by standard for 1 TB/second with 16 lanes.

### DESCRIPTION OF INVENTION

PCI Express (PCIE) is an IO interconnect standard that is developed and implemented as a tree network within Computers and servers for connecting to peripheral devices. Currently PCIE has achieved stability such that PCIE can be used as a basis for other applications. A PCIE based scheme inter-connecting multiple PCIE enabled processing systems as a cluster with at least one PCIE root complex controlling at least a PCIE bus, enabling the scalability of PCIE architecture to be applied for data transport between the connected system is disclosed in U.S. application Ser. No. 11/242,463 titled “PCI Express to PCI Express based low latency interconnect scheme for clustering systems” filed on Oct. 4, 2005 which issued as U.S. Pat. No. 8,189,603 on May 29, 2012 and its continuations. The interconnection uses an outbound port enabled for system interconnection on the PCIE bus of each PCIE enabled computer connecting to one inbound port on an independently programmable network switch having a plurality of inbound ports. The interconnection is using PCIE protocol for data transfer within the cluster to interconnect processors, memory controllers, storage and other network components in Data centers.

PCI express with its capability of interconnecting and forming clusters/groups of memories and processors with data transfer capability using PCIE protocol (without any protocol conversion) for data transfer between the interconnected devices and groups allow high speed transfer of data directly into memories and storage devices and processors within an AI module in the large language model (LLM) environment. PCIE also enable direct memory access (DMA) and remote direct memory access (RDMA) to write and retrieve data from storage clusters and clusters of GPUs operating as accelerators without the involvement of CPUs. The capability for DMA and RDMA eliminates the load on processors to accept and write data into memory clusters and between GPUs thereby enabling the CPU to be used more efficiently for processing the available data.

The interconnection uses PCIE protocol for data transfer within the interconnected clusters of processors, memory controllers, storage and other system components of the AI system within the LLM environment.

Peripheral component Interconnect Express (PCIE) or PCI Express® or (PCIe®) as it is known is a standard that is continuing to evolve and the standard is handled PCIe standards group (PCIe.Sig.). The current PCIe version is the PCIe.7 with PCIe.8 standard in evolution. PCIE 7 providing 256 GB/second speeds with 16 lanes today and PCIE 8 standard is specified for 1 TB/second with the 16 lanes.

Processing systems of today are being challenged to process more intricate and diverse types of workloads in cloud, hybrid-cloud and enterprise data centers (Hybrid Data Centers).

State-of-the-art Generative AI applications require immense computational power supplied by thousands of Graphics Processing Units (GPUs) working in tandem as accelerators to process complex calculations and massive datasets involved in responding to the queries and also for handling the training using Large Language Models (LLMs). Using the PCIE interconnect allows the GPUs acting as accelerators and connected peripheral units a to transfer data using direct memory access or remote direct memory access depending on the connections. Typically, the data transfer between the GPU's VRAM memories is using direct memory access (DMA) when within a cluster or remote direct memory access (RDMA) when the transfer is from a different cluster or storage. The data transfer between the GPU memories and storage devices via the NICs are also enabled by RDMA without involvement of CPUs. The volume of data being collected, stored and processed by the AI systems is growing exponentially and the memory, power and processing capabilities have to keep pace.

Traditional compute servers used in AI must accommodate a diverse set of applications that can be processor, memory, networking, and storage intensive to varying degrees depending on the application use case.

PCIe technology offers many benefits for a diverse set of high-performance servers, including:
1. Scalable connectivity via expansion cards and peripherals including compute accelerators, network modules, graphics cards, and storage devices in addition to memory via compute express link (CXL).
2. Hot-plug so components can be swapped out while the server is running, minimizing system downtime.
3. Multiple PCIe link widths (x1, x2, x4, x8, x16), enabling servers to right-size the connectivity bandwidth link to the solution requirements.
4. Backwards compatibility, preserving customer investment and extending equipment longevity.
5. The PCIE is still an evolving interconnect technology, standards moving from PCIE 7 to PCIE 8 and moving to PCIE 9 at present.

Overall, PCIe technology is a powerful and versatile connectivity interconnect that is essential for the performance and scalability of high-performance servers, processors and accelerators and it will continue to play an important role in meeting the demands of new and emerging applications including the AI with ML applications.

PCIE or PCI Express® _(PCIe®) technology has long been an integral part of servers. It was initially used for point-to-point connectivity of peripheral components, network adapters and storage controllers to a single host processor. PCIe technology today has expanded to interconnect many CPUs and processors to each other, and it has further advanced currently to connect additional memory using memory expansion components (not shown in figures). The PCIe specification continues to evolve its use case as the critical connectivity backbone on which interconnected groups of all servers, processors and associated memory components can operate efficiently.

The PCIE of today has become the backbone of the datacenter infrastructure and connectivity. PCIE is used to enable high-speed, low latency data transfer between clusters of CPUs, GPUs, Memory controllers, data storage systems and other network components within AI with ML capability within any large language model (LLM) environment. Use of PCI interconnect has also enabled the network to operate in conjunction with Ethernet with low data loss using data loss control programs such as per flow control (PFC) within the Data centers. The PCIE interconnection providing clustering capability to a plurality of CPUs, GPUs, other processors and storage systems. The PCIE interconnected diverse processing systems, servers, memories and storage devices and components are able to handle and support the intensive work loads due to the artificial intelligence (AI) with machine learning (ML) and large language models (LLM)s in use. The backwards compatibility and capability to be flexible in connectivity without sacrificing the speed of connectivity and integrity of data within the clusters make it a crucial part and component of the dis-aggregated data centers, including the hybrid data centers comprising cloud-based and on premises infrastructure for providing control and security of data at lower cost, flexibility and scalability fort use by the AI within LLM environments at these data centers.

As indicated above PCI Express (PCIE) has achieved a prominent place as the I/O interconnect standard for use inside computers, processing system and embedded systems that allow serial high speed data transfer to and from peripheral devices. The original PCIE provided 2.5-3.8 GB transfer rate per link or lane while the PCIE.7 the current PCIE provides 128 GB/sec and the next generation PCIE standard approved is designated for 1 TB/second using preferably optical pulse amplitude modulation (PAM4) signaling and fixed size flow control units(FLITs) (the data transfer rates may still change as the standards and data transfer technologies change). The PCIE standards are evolving fast, becoming faster and firm and used within more and more systems. (The PCI SIG is responsible for upgrading the PCIE specifications and is continuously working to improve the speed and increase the bands width of the PCIE to meet the demands of the customers.)

Typically, each PCIE based system has a root complex which controls all connections and data transfers to and from connected peripheral devices through PCIE peripheral end points or peripheral modules. What is disclosed is the use of PCIE standard based switches enabled for interconnection to similar PCIE standard system components, PCIE based peripheral and other PCIE standard based switches, connected directly using PCIE data links, as an interconnect between multiple systems, forming operating clusters typically through one or more PCIE standard based independently programmable network switches. This interconnect scheme by using PCIE based protocols for data transfer over direct physical connection links between the PCIE based devices, (see FIG. 1), without any intermediate conversion of the transmitted data stream to other data transmission protocols or encapsulation of the transmitted data stream within other data transmission protocols, thereby reducing the latencies of communication between the connected PCI based systems within the cluster. The PCIE standard based peripherals enabled for interconnection at a peripheral end points of the PCIE based system, by directly connecting using PCIE standard based links to PCI enabled switches, systems and peripherals using PCIE standard based direct data link connections, provide for increase in the number of links per connection as bandwidth needs of system interconnections increase and thereby allow scaling of the band width available within any single interconnect or the system of interconnects as required.

Referring to FIG. 3A,300A; FIG. 3B, 300B and FIG. 4, 400 they show the exemplary and non-limiting implementation of an LLM environment with AI with clustered processing capability using PCIE interconnect.

FIG. 4, 400 shows an exemplary and non-limiting implementation to show the capability of PCIE for interconnecting the components and network within an LLM environment 403 comprising an Artificial intelligence system 404 in a data center. The incoming customer requests and data streams 401 and 401A into the LLMM environment 403 comes into a gateway 402 typically over ethernet links 401 and 401A. The AI with ML capability 404 in the LLM environment 403 has a data interface 405 for accepting the incoming Data streams from the gate way, 402; an App service 406 acts as a managed application checker that enable the user inputs to access the AI models managing the infrastructure, security and integration. An AI production service 410 is a data driven system for optimizing manufacturing and operational workflows using AI capabilities and comprise modules 408 that may be relevant models for a manufacturing flow and 409 the AI agents for workflow optimization. A data store 411 may be used to hold all the data required for training the AI for operation and a retravel augmented generation (RAG) 412 provides the capability for the LLM to assimilate and update itself to be current in time for responding to customer requests. The block 407 within the AI with ML capability 404 contains all the processing infrastructure including capability comprising CPUs, GPUs, etc. associated with the AI with ML capability 404 which may be used by the various other components of the AI with ML capability 404.

The network fabric within data centers is typically using network fabric switches (not shown in FIGs) as nodes with ethernet connectivity forming the network fabric within most Data centers. These nodes may have PFC based flow control to prevent data loss. The network fabric may contain the AI/LLM module of FIG. 4, 400 is connected via NIC 306 and PCIE links 308B of FIG. 3A, 300A; from a switch 302-2 enabled for system interconnection, to the local network fabric switch connected by Ethernet. The PCIE enabled switch 302-2 which is part of the larger cluster comprising switches 302-1 and 302-2. These switches enabled for system interconnection form the clusters of processors, CPUs 301-1 to 301-4 and GPUs 304-1 to 304-5, and peripherals for applications 305-1 to 305-2 and storage 307 connected via a NIC 306, (all using PCIE protocol over PCIE links 308, 308A, 308B, 309-1 to 309-4) necessary for the operation of the AI 404 in the LLM environment 403. The switches interconnected by PCIE-links enable the clustering of the processing units comprising CPUs, 301-1 to 301-4 each with system memory 303-1 to 303-4 and GPUs 304-1 to 304-5 each with their own VRAM memory. The PCIE interconnection also enable storage and retrieval capability needed for processing the large volume of data necessary for AI and LLM. A large number of processing systems comprising processors/GPUs, 304-1 to n, example shown in FIG. 3A, GPU 304-1 to 304-5, are interconnected as a large cluster using the PCIE enabled switches, example shown in FIG. 3A using switches −1 and 302-2. Data gets transferred to and from the Ethernet nodes in the data center to the LLM environment to the coupled PCIE enabled switch 302-2 enabled for system interconnection and hence the cluster 300A that is part of the LLM environment 403 comprising the AI with ML capability to process data. The CPUs 301-1 to 301-4 and GPUs 304-1 to 304-5 within the cluster may be further connected to Re-timers, Memory/Flash controllers, and additional switches for coupling more peripheral and other application specific devices to the cluster 300A. The connections within the LLM environment 403 comprising the AI with ML capability 404 in the LLM environment 403, is using PCIE links and using PCIE protocol. By this scheme of interconnection, a large volume of data processing capability is possible within the LLM environment 403, either in on-premises private data center, cloud based data center, or a hybrid data center integrating the two types together. The clusters so formed may be expanded further to large size clusters by linking additional PCIE enabled switches similar to 302-1 to 302-2 as per this application.

The use of PCIE interconnection as discussed before is an enabler for RDMA and DMA

The DMA and RDMA capability is instrumental in high volume, high speed data transfer necessary between the GPUs and between GPUs and storage. The DMA and RDMA capability eliminates the intermediate CPU involvement during data transfers speeding up the operation of the AI 404 in the LLM environment 403.

Without RDMA capability the transfer of data from the VRAM memory of one GPU(A) to the VRAM memory of another GPU(B) follows the sequence below:
GPU A (VRAM)→copy→CPU A DRAM→copy→CPU B DRAM→GPU B (VRAM)

With RDMA capability the same data transfer eliminates two data copy requirements and the involvement of two CPUs as below:
GPU A (VRAM)→copy→GPU B (VRAM).

As shown above the data transfer between GPUs in a cluster is completed with no involvement of the CPU using DMA, thereby reducing the number of steps from 4 steps to 2 steps.

FIG. 3B, 300B shows the transfer of data 311 between GPUs 304-1 and 304-2, in a cluster with both GPUs connected to the same switch 302-1 using DMA. Similarly, 312 shows the data transfer using DMA within the larger cluster between GPU 304-2 and GPU 304-4 where the GPU 304-2 is connected by PCIE links to switch 302-1 and GPU 304-4 is connected to switch 302-2 and the switches 302-1 and 302-2 are linked and enabled for data transfer for from one to another and enabled to form the larger cluster.

Similarly the GPUs are able to access data stored in storage directly using RDMA which also eliminates unnecessary copies of data being produces and relieves the CPUs from operating as intermediaries.

The data transfer to a GPUs and from a GPUs to storage use RDMA. 313 and 314 together show this capability (the direction of 314 and 313 are reversible) . 314 shows the transfer of data to and from the storage 307 to a NIC that is connected to the switch 302-1 and 313 shows the transfer of Data from the NIC to the one of the GPUs, for example 304-4.

By using DMA and RDMA for data transfer the capability leaves the CPUs 301-1 to 301-4 of the cluster free to handle other priority operation requiring attention of the CPUs 301-1 to 301-4. The use of the DMA and RDMA hence speeds up and optimizes the use of available capabilities of the AI with ML capability 404 in the LLM environment 403

### Some Advantages of the Proposed Connection Scheme

1. Reduced Latency of Data transfer as conversion from PCIE to other protocols are avoided during transfer.
2. The number of links per connection can scale from X1 to larger numbers X32 or even X64 as PCIE capabilities increase to cater to the connection bandwidth needed. Minimum change in interconnect architecture is needed with increased bandwidth, enabling easy scaling with need.
3. Any speed increase in the link connection due to technology advance is directly applicable to the interconnection scheme.
4. Standardization of the PCIE based peripheral will make components easily available from multiple vendors, making the implementation of interconnect scheme easier and cheaper.
5. The PCIE based peripheral to PCIE based peripheral links in connections allow ease of software control and provide reliable bandwidth.

### BRIEF DESCRIPTION OF FIGURES

FIG. 1 Typical Interconnected (multi-system) cluster (shown with eight systems connected in a star architecture using direct connected data links between PCIE standard based peripheral to PCIE standard based peripheral)

FIG. 2—is a cluster using multiple interconnect modules or switches enabled for system interconnection to interconnect smaller clusters.

FIG. 3A—is a typical connection scheme showing the PCIE interconnect enabling clustering of CPUs and clustering of GPUs operating as accelerators in a system comprising AI with ML capability.

FIG. 3B—is a typical and nonlimiting block diagram of the PCIE based clustering interconnection within the AI within an LLM environment enabling RDMA and DMA for handling the high volume of data processing using clustered GPUs and storage.

FIG. 4—is an exemplary block diagram of an AI within the LLM environment

### Explanation of Numbering and Lettering in the Figures

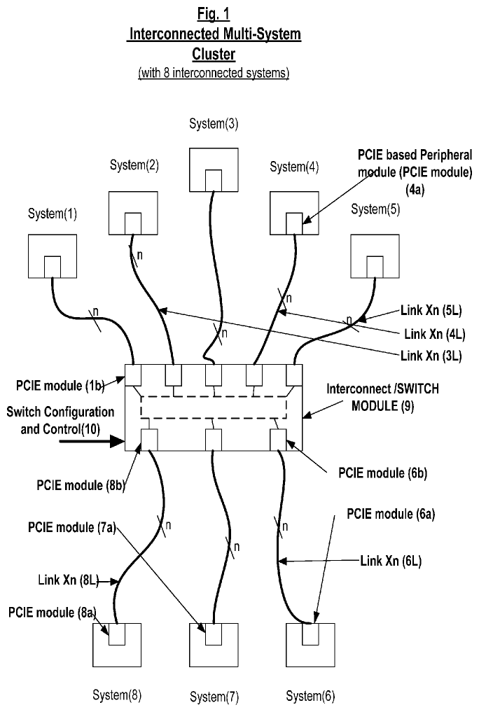

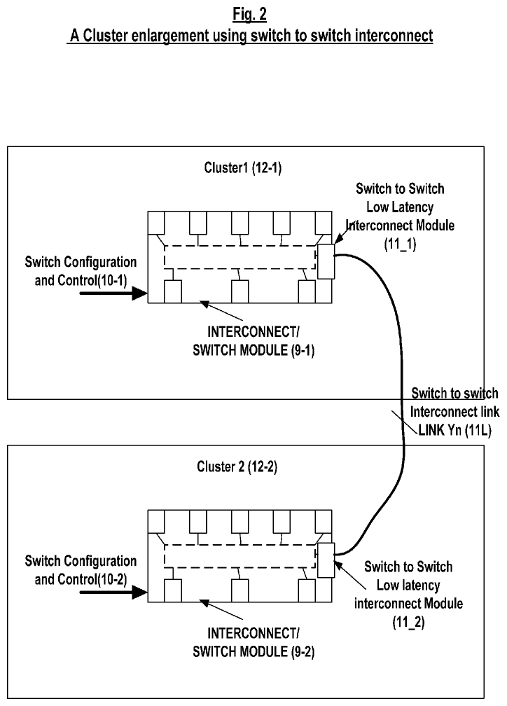

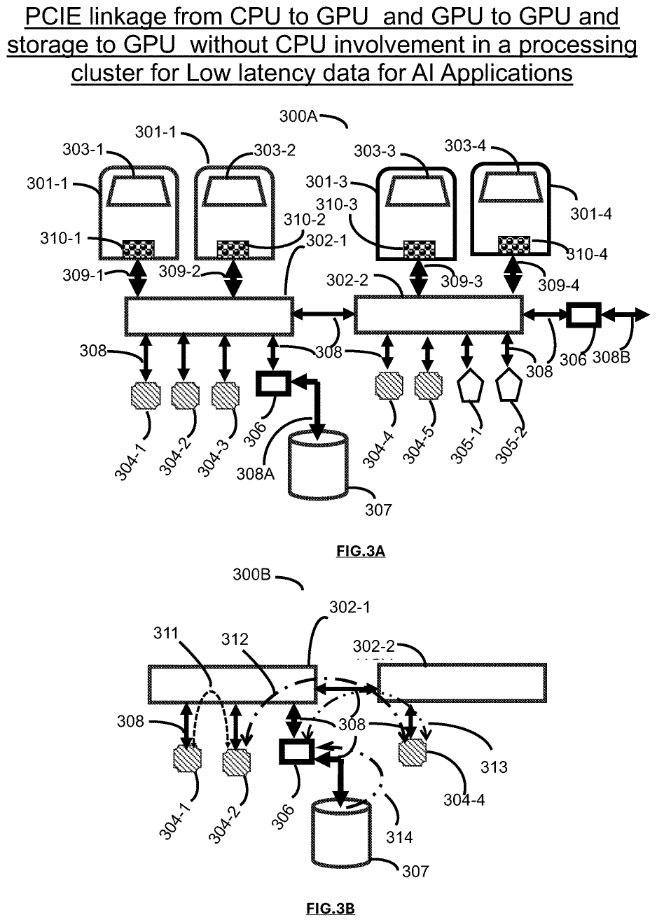

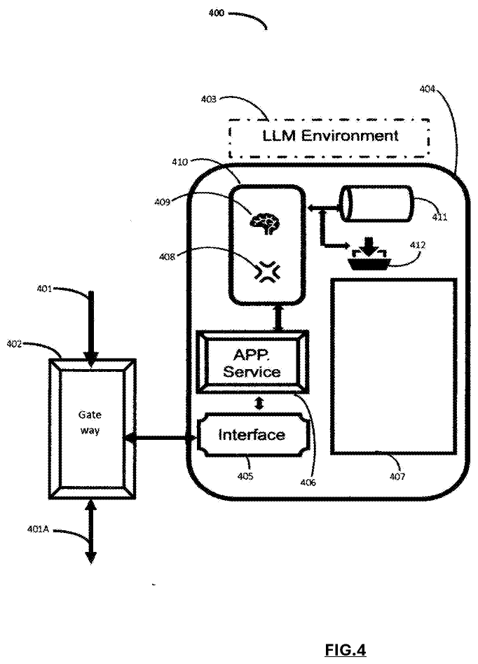

FIG. 1
   (1) to (8): Number of Systems interconnected in FIG. 1
   (9): Switch sub-system
   (10): Software configuration and control input for the switch. (1a) to (8a): PCI Express based peripheral module (PCIE Modules) attached to systems.
   (1b) to (8b): PCI Express based peripheral modules (PCIE Modules) at switch.
   (1L) to (8L): PCIE based peripheral module to PCIE based peripheral module connections having 5 n-links (n-data links).
FIG. 2
   (12-1) and (12-2): clusters.
   (9-1) and (9-2): interconnect modules or switch sub-systems.
   (10-1) and (10-2): Software configuration inputs.
   (11-1) and (11-2): Switch to switch interconnect module in the cluster.
   (11L): Switch to switch interconnection
FIG. 3A
   300A—Exemplary Interconnection of CPUs, GPUs and memories using PCIE within an AI within an LLM environment
   301-(1 to 4)—CPUs connected in cluster
   302-(1 and 2)—Interconnection enabling Switches (the switches enabled for system interconnection)
   303-(1 to 4)—CPU memory
   304-(1 to 4)—interconnected GPUs in cluster [each GPU with its own VRAM]
   305-(1 and 2) other peripheral components used in applications
   306—NICs for external interconnection to storage and to network
   307—Storage such as NAS connected through a NIC to the AI in an LLM environment
   308—PCIE links
   308A—connection to storage 307 from NIC 306
   308B—connection to network fabric switch from NIC 306
   309-(1 to 4)—PCIE links connecting an outbound port on an end point of a PCIE bus enabled for system interconnection to the switches enabled for system interconnection.
   310-(1 to 4)—Root complex of the CPU controlling a PCIE bus.
FIG. 3B
   300B—Exemplary diagram indication the use of RDMA and DMA for data transfer within the interconnected cluster of GPUs and storage
   311—Transferring and sharing data between GPUs connected to a switches enabled for system interconnection (304-1 to 304-2) using DMA
   312—Transferring and sharing of data between GPUs within a larger cluster comprising two switches enabled for system interconnection (304-2 to 304-4) using DMA
   313 and 314—Transferring data from storage to NIC (307 to 306) and from NIC to GPU (306 to 304-4) using RDMA
FIG. 4
   401 and 401A—data flows and customer requests
   402—gate way to the AI with ML capability in the LLM environment
   403—the LLM environment comprising the AI with ML capability
   404—The AI with ML capability
   405—Data interface into the AI with ML capability
   406—APP service within the AI with ML capability
   407—The processing infrastructure of the AI with ML capability
   408—models for optimizing manufacturing and operational workflows
   409—AI agents for workflow optimization
   410—AI production service
   411—storage for LLM models
   412—Retrieval Augmented generation (RAG) capability

### FURTHER DESCRIPTION OF THE INVENTION (PREVIOUSLY INTRODUCED) FOR CLUSTERING

PCI Express (PCIE) was developed as an IO interconnect standard that is implemented as a tree network with a root complex connecting to a CPU having one or more processors. The root complex acts as the root node for use inside the computer for connecting to peripheral devices.

Currently PCIE has achieved stability such that PCIE can be used as a basis for other applications.

A PCIE based scheme inter-connecting multiple PCIE enabled computer systems each having at least one PCIE root complex controlling at least a PCIE bus, enabling the scalability of PCIE architecture to be applied for data transport between the connected system cluster is proposed.

The interconnection uses an outbound port enabled for system interconnection on the PCIE bus of each PCIE enabled computer connecting to one inbound port on an independently programmable network switch having a plurality of inbound ports. The interconnection is using PCIE protocol for data transfer within the cluster.

PCIE is a Bus standard for use inside the computer or embedded system enabling faster data transfers to and from peripheral devices. The standard is still evolving but has achieved a degree of stability such that other applications can be implemented using PCIE as basis. A PCIE based interconnect scheme to enable switching and inter-connection between multiple PCIE enabled systems each having its own PCIE root complex, such that the scalability of PCIE architecture can be applied to enable data transport between connected systems to form a cluster of systems, is proposed. These connected PCIE enabled systems can be any computing, control, storage or embedded systems. The scalability of the interconnect will allow the cluster to grow the bandwidth between the systems as they become necessary without changing to a different connection architecture.

FIG. 1 is a typical cluster interconnect. The Mul@-system cluster shown consist of eight units or systems {(1) to (8)} that are to be interconnected. Each system is PCI Express (PCIE) based system with a PCIE root complex for control of data transfer to and from connected peripheral devices via PCIE peripheral modules as is standard for PCIE based systems. Each system to be interconnected has at least a PCIE based peripheral module {(1a) to (8a)} as an IO module, at the interconnect port enabled for system interconnection, with n-links built into or attached to the system. (9) is an interconnect module or a switch sub-system, which has number of PCIE based connection modules equal to or more than the number of systems to be interconnected, in this case of FIG. 1 this number being eight {(1b) to (8b)}, that can be interconnected for data transfer through the switch. A software based control input is provided to configure and/or control the operation of the switch and enable connections between 5 the switch ports for transfer of data. Link connections {(1L) to (8L)} attach the PCIE based peripheral modules 1a to 8a, enabled for interconnection on the respective systems 1 to 8, to the on the switch with n links. The value of n can vary depending on the connect band width required by the system.

When data has to be transferred between say system 1 and system 5, in the simple case, the control is used to establish an internal link between PCIE based peripheral modules 1b and 5b at the respective ports of the switch. A hand-shake is established between outbound communication enabled PCIE based peripheral module (PCIE Module) 1a and inbound PCIE module 1b at the switch port and outbound PCIE module 5a on the switch port and inbound communication enabled PCIE module 5b. This provides a through connection between the PCIE modules 1a to 5b through the switch allowing data transfer. Data can then be transferred at speed between the modules and hence between systems. In more complex cases data can also be transferred and queued in storage implemented in the switch, at the ports and then when links are free transferred out to the right systems at speed.

Multiple systems can be interconnected at one time to form a multi-system that allow data and information transfer and sharing through the switch. It is also possible to connect smaller clusters together to take advantage of the growth in system volume by using an available connection scheme that interconnects the switches that form a node of the cluster.

If need for higher bandwidth and low latency data transfers between systems increase, the connections can grow by increasing the number of links connecting the PCIE modules between the systems in the cluster and the switch without completely changing the architecture of the interconnect. This scalability is of great importance in retaining flexibility for growth and scaling of the cluster.

It should be understood that the system may consist of peripheral devices, storage devices and processors and any other communication devices. The interconnect is agnostic to the type of device as long as they have a PCIE module at the port to enable the connection to the switch.

This feature will reduce the cost of expanding the system by changing the switch interconnect density alone for growth of the multi-system.

PCIE is currently being standardized and that will enable the use of the existing PCIE modules to be used from different vendors to reduce the overall cost of the system. In addition, using a standardized module in the system as well as the switch will allow the cost of software development to be reduced and in the long run use available software to configure and run the systems.

As the expansion of the cluster in terms of number of systems, connected, bandwidth usage and control will all be cost effective, it is expected the overall system cost can be reduced and over all performance improved by standardized PCIE module use with standardized software control.

Typical connect operation may be explained with reference to two of the systems, example system (1) and system (5). System (1) has a PCIE module (1a) at the interconnect port and that is connected by the connection link or data-link or link (1L) to a PCIE module (1b) at the IO port of the switch (9). System (5) is similarly connected to the switch trough the PCIE module (5a) at its interconnect port to the PCIE module (5b) at the switch (9) IO port by link (5L). Each PCIE module operates for transfer of data to and from it by standard PCI Express protocols, provided by the configuration software loaded into the PCIE modules and switch. The switch operates by the software control and configuration loaded in through the software configuration input.

FIG. 2 is that of a multi-switch cluster. As the need to interconnect larger number of systems increases, it will be optimum to interconnect multiple switches of the clusters to form a new larger cluster. Such a connection is shown in FIG. 2. The shown connection is for two smaller clusters (12-1 and 12-2) interconnected using PCIE modules that can be connected together using any low latency switch to switch connection (11-10 and 11-2), connected using interconnect links (11L) to provide sufficient band width for the connection. The switch to switch connection transmits and receives data and information using any suitable protocol and the switches provide the interconnection internally through the software configuration loaded into them.

The following are some of the advantages of the disclosed interconnect scheme
1. Provide a low latency interconnect for the cluster.
2. Use of PCI Express based protocols for data and information transfer within the cluster.
3. Ease of growth in bandwidth as the system requirements increase by increasing the number of links within the cluster.
4. Standardized PCIE component use in the cluster reduce initial cost.
5. Lower cost of growth due to standardization of hardware and software.
6. Path of expansion from a small cluster to larger clusters as need grows.
7. Future proofed system architecture.
8. Any speed increase in the link connection due to technology advance is directly applicable to the interconnection scheme.

In-fact the disclosed interconnect scheme provides advantages for low latency multi-system cluster growth that are not available from any other source.

While the invention has been described in terms of several embodiments, those of ordinary skill in the art will recognize that the invention is not limited to the embodiments described, but can be practiced with modification and alteration within the spirit and scope of the appended claims. Multiple existing methods and methods developed using newly developed technology may be used to establish the handshake between systems and to improve data transfer and latency. The description is thus to be regarded as illustrative instead of limiting and capable of using any new technology developments in the field of communication and data transfer. There are numerous other variations to different aspects of the invention described above, which in the interest of conciseness have not been provided in detail. Accordingly, other embodiments are limited only within the scope of the claims.

What is claimed is:

1. A system;
The system is a peripheral component interconnect express (PCIE) based system;
the system enabled for interconnection and clustering of a plurality of processors and peripherals in an artificial Intelligence (AI) capability, to provide the AI a capability to handle a volume of customer requests and associated volume of data streams.

2. The system of claim 1, wherein all the interconnections for data transfer within the AI capability is using PCIE protocol over PCIE links.

3. The system of claim 2, wherein the clustering of processors use switches enabled for interconnection.

4. The system of claim 3, wherein the interconnection for clustering uses PCIE protocol over PCIE links and switches enabled for interconnection.

5. The system of claim 4, wherein the Processors comprise CPUs and GPUs.

6. The system of claim 5, wherein the switches are interconnectable using PCIE links for expanding the cluster size by linking two clusters comprising CPUs and GPUs interconnected using each switch.

7. The system of claim 6, wherein the GPUs are accelerators.

8. The system of claim 7, wherein the use of PCIE based interconnect enable the use of direct memory access (DMA) and remote direct memory access (RDMA) to transfer data between GPUs within the clusters.

9. The system of claim 7, wherein the use of PCIE based interconnect enable the use of Remote direct memory access (RDMA) to transfer data from storage to GPUs.

10. The system of claim 9, wherein the data transfers using of DMA and RDMA do not involve the CPUs in the cluster.

11. The system of claim 10, wherein the use of DMA and RDMA speed up the processing of data in the AI capability.

12. A system;
the system for improving the volume and speed of data processed within an artificial Intelligence (AI) environment;
the system using peripheral component interconnect express (PCIE) protocol over PCIE links for clustering of a processing capability within the AI environment;
the clusters of processing capability comprising interconnected CPUs and GPUs, interconnected in a cluster.

13. The system of claim 12, wherein the system uses PCIE protocol over PCIE links for all interconnection within the AI environment.

14. The system of claim 13, wherein the clustering further uses switches enabled for interconnection.

15. The system of claim 14, wherein the use of PCIE protocol over PCIE links enabling DMA and RDMA for data transfer.

16. The system of claim 15, wherein the data transfer between GPUs in a cluster in using DMA.

17. The system of claim 15, wherein the data transfer between a GPU and a storage system is using RDMA.

18. The system of claim 15, wherein the use of DMA and RDMA for data transfer frees up the CPUs in the cluster.

19. The system of claim 15, wherein the use of DMA and RDMA for data transfer to and from GPUs speed up the processing of data within the AI environment.
